(19) United States
(12) Patent Application Publication
(10) Pub. No.: US 2016/0081096 A1
(43) Pub. Date: Mar. 17, 2016

(54) CENTRALIZED WIFI CHANNEL SELECTION

(71) Applicant: QUALCOMM Incorporated, San Diego, CA (US)

(72) Inventors: Marc Walter WERNER, Heroldsberg (DE); Andrea GARAVAGLIA, Nuremberg (DE); Patrick STUPAR, Nuremberg (DE); Kambiz AZARIAN YAZDI, San Diego, CA (US)

(21) Appl. No.: 14/484,762

(22) Filed: Sep. 12, 2014

(51) Int. Cl. H04W 72/08; H04W 84/12

(52) U.S. Cl. CPC H04W 72/08; H04W 84/12; H04W 88/08

(57) ABSTRACT

Methods and apparatus for performing dynamic channel selection are provided. In an example, a method includes receiving, at a central self-organizing network server, data from an access point (AP) including a number of stations associated with the AP. The method includes calculating downlink capacities for the associated stations and selecting a channel for the AP which maximizes a pre-defined network utility that is based on the downlink capacities. Further, it is determined if the network utility gain resulting from selecting the channel exceeds a threshold when compared to a previous channel selection state. If the network utility gain exceeds the threshold, a channel change command is issued to the AP, directing the AP to use the selected channel to communicate with a specific station.

### INTRODUCTION

Aspects of this disclosure relate generally to electronics, and more specifically, but not exclusively, to methods and apparatus that select a WiFi channel and the like.

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). One class of such multiple-access systems is generally referred to as “WiFi,” and includes different members of the Institute of Electrical and Electronics Engineers (IEEE) 802.11 wireless protocol family. Generally, a WiFi communication system can simultaneously support communication for multiple wireless stations (STAs). Each STA communicates with one or more access points (APs) via transmissions on the downlink and the uplink. The downlink (DL) refers to the communication link from the APs to the STAs, and the uplink (UL) refers to the communication link from the STAs to the APs.

In conventional WiFi networks, an AP, upon powering up, initially selects one transmission channel out of a set of available channels. The selection is based on preconfiguration settings or on simple measurements such as a total received power or concurrent AP count on each channel. This selection method is simple, but usually provides suboptimal performance with respect to typical performance indicators such as overall throughput per AP. The suboptimal performance usually continues unmitigated, as the conventional AP maintains the selected channel, even if transmission conditions degrade over time.

Some WiFi networks use a Dynamic Channel Selection method in an uncoordinated WiFi scenario. The Dynamic Channel Selection method dictates that each AP should operate on a “best” available channel at all times, where the “best” channel is defined, for example, by a maximum average throughput per user station. However, the Dynamic Channel Selection method can seriously impact low-signal to interference and noise ratio (SINR) STAs. In other words, under the Dynamic Channel Selection method, it is possible that a STA having a low SINR is not treated fairly relative to a STA having a high SINR. Thus, the STA having the low SINR continues to receive a channel assignment that fails to correct the STA's low SINR, and the STA having the low SINR suffers from poor throughout (e.g., has a low data rate for an unnecessarily long time).

Accordingly, there are long-felt industry needs for methods and apparatus that improve upon conventional methods and apparatus, including the improved methods and apparatus provided hereby.

### SUMMARY

This summary provides a basic understanding of some aspects of the present teachings. This summary is not exhaustive in detail, and is neither intended to identify all critical features, nor intended to limit the scope of the claims.

The word “exemplary” is used herein to mean “serving as an example, instance, or illustration.” Any aspect described herein as “exemplary” is not necessarily to be construed as preferred or advantageous over other aspects disclosed.

Exemplary methods and apparatus for performing dynamic channel selection are provided. An exemplary method includes receiving, at a central self-organizing network server, data from an access point (AP) including a number of stations associated with the AP; calculating downlink capacities for the associated stations; selecting a channel for the AP which maximizes a pre-defined network utility that is based on the downlink capacities; determining if the network utility gain resulting from selecting the channel exceeds a threshold when compared to a previous channel selection state; and issuing, if the network utility gain exceeds the threshold, a channel change command to the AP directing the AP to use the selected channel to communicate with a specific station. The method can further include starting channel assignments from a current channel assignment, a predetermined channel assignment, or a random channel assignment.

In a further example, provided is a non-transitory computer-readable medium, comprising instructions stored thereon that, if executed by a processor, such as a special-purpose processor, cause the processor to execute at least a part of the aforementioned method.

In another example, provided is an apparatus configured to perform dynamic channel selection. The apparatus includes means for receiving, at a central self-organizing network server, data from an access point (AP) including a number of stations associated with the AP; means for calculating downlink capacities for the associated stations; means for selecting a channel for the AP which maximizes a pre-defined network utility that is based on the downlink capacities; means for determining if the network utility gain resulting from selecting the channel exceeds a threshold when compared to a previous channel selection state; and means for issuing, if the network utility gain exceeds the threshold, a channel change command to the AP directing the AP to use the selected channel to communicate with a specific station. The apparatus can further include means for starting channel assignments from a current channel assignment, a predetermined channel assignment, or a random channel assignment.

In another example, provided is an apparatus configured to perform dynamic channel selection. The apparatus includes a processor; and a memory coupled to the processor and storing instructions configured to cause the processor to: receive, at a central self-organizing network server, data from an access point (AP) including a number of stations associated with the AP; calculate downlink capacities for the associated stations; select a channel for the AP which maximizes a pre-defined network utility that is based on the downlink capacities; determine if the network utility gain resulting from selecting the channel exceeds a threshold when compared to a previous channel selection state; and issue, if the network utility gain exceeds the threshold, a channel change command to the AP directing the AP to use the selected channel to communicate with a specific station. The memory can further store instructions configured to cause the processor to start channel assignments from a current channel assignment, a predetermined channel assignment, or a random channel assignment.

### BRIEF DESCRIPTION OF THE DRAWINGS

The accompanying drawings are presented to describe examples of the present teachings, and are not limiting.

FIG. 1 depicts an exemplary wireless communication network employing a WiFi protocol.

FIG. 2 depicts a functional block diagram of an exemplary user device.

FIG. 3 depicts a functional block diagram of an exemplary access point.

FIG. 4 depicts an exemplary Carrier Wireless Local Access Network Self-Organizing Network server.

FIG. 5 depicts an exemplary method for performing dynamic channel selection.

FIG. 6 depicts exemplary results of implementing the channel selection method of FIG. 5.

FIG. 7 is a simplified block diagram of several sample aspects of components that may be employed in communication nodes and configured to support communication as taught herein.

FIGS. 8-9 are other simplified block diagrams of several sample aspects of apparatuses configured to support communication as taught herein.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

Methods and apparatus that select a WiFi channel are provided. The exemplary apparatuses and methods disclosed herein advantageously address the long-felt industry needs, as well as other previously unidentified needs, and mitigate shortcomings of the conventional methods and apparatus. For example, an advantage provided by the disclosed apparatuses and methods herein is an improvement in balance of fairness against average throughput over conventional devices. Another advantage is improved data throughput. Signalling overhead is also reduced. The disclosed apparatuses and methods also address a dynamically-changing traffic environment, and can jointly optimize both low-percentile and high-percentile station capacities to balance channel allocation over a capacity CDF curve.

Examples are disclosed in this application's text and drawings. Alternate examples can be devised without departing from the scope of the teachings. Additionally, conventional elements of the current teachings may not be described in detail, or may be omitted, to avoid obscuring aspects of the current teachings.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

### ABBREVIATIONS

The following abbreviations that may be found in the application are defined as follows:
AP—access point.
C—capacity (e.g., a maximum data reception rate of a station).
CDF—cumulative distribution function.
CWLAN—carrier wireless (e.g., WiFi) local area network.
CSMA—carrier-sense multiple access.
DCS—dynamic channel selection.
DL—downlink.
IEEE—Institute of Electrical and Electronics Engineers. A standards body responsible for developing computing and electronics standards. The IEEE developed 802.11x standards for WLANs (wireless local area networks).
IP—internet protocol.
LAN—local area network. A communication network covering a limited area.
SINR—signal to (interference+noise) ratio
SON—self-organizing network. For example, a SON can self-configure based on a wireless transmission environment. In an example, the SON can self-optimize operation in response to changes in network performance and the wireless transmission environment.
STA—station. In an example, a station can be user equipment.
UE—user equipment.
UL—uplink.
WBA—Wireless Broadband Alliance.
WiFi—Short for “Wireless Fidelity” and another name for WLAN (wireless local area network). A WiFi device can be compatible with a WiFi standard, such as standard IEEE 802.11n, standard IEEE 802.11ac, standard IEEE 802.11k, and the like. A WiFi device can allow a mobile user to connect to a local area network (LAN) through a wireless connection.
WLAN—wireless local area network. Can allow a mobile user to connect to a local area network (LAN) through a wireless connection.

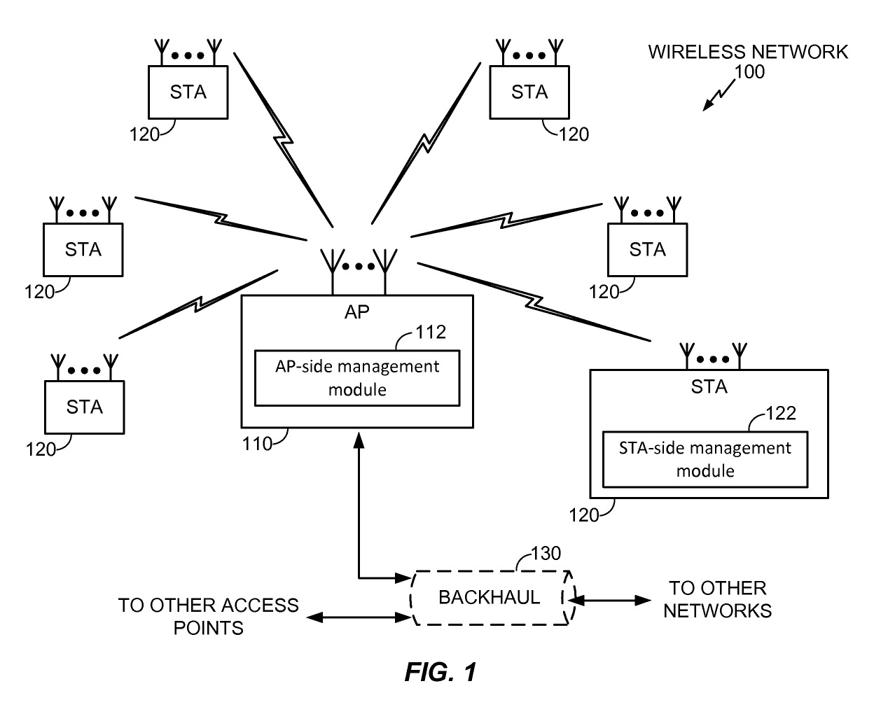

FIG. 1 illustrates an example wireless network 100. As shown, the wireless network 100, which may also be referred to herein as a Basic Service Set (BSS), is formed from several wireless nodes, including an Access Point (AP) 110 and a plurality of subscriber stations (STAs) 120. Each wireless node is generally capable of receiving and/or transmitting. The wireless network 100 may support any number of APs 110 distributed throughout a geographic region to provide coverage for the STAs 120. For simplicity, one AP 110 is shown in FIG. 1, providing coordination and control among the STAs 120, as well as access to other APs or other networks (e.g., the Internet) via a backhaul connection 130.

The AP 110 is generally a fixed entity that provides backhaul services to the STAs 120 in its geographic region of coverage. However, the AP 110 may be mobile in some applications (e.g., a mobile device serving as a wireless hotspot for other devices). The STAs 120 may be fixed or mobile. Examples of STAs 120 include a telephone (e.g., cellular telephone), a laptop computer, a desktop computer, a personal digital assistant (PDA), a digital audio player (e.g., MP3 player), a camera, a game console, a display device, or any other suitable wireless node. The wireless network 100 may be referred to as a wireless local area network (WLAN), and may employ a variety of widely used networking protocols to interconnect nearby devices. In general, these networking protocols may be referred to as “WiFi,” including any member of the Institute of Electrical and Electronics Engineers (IEEE) 802.11 wireless protocol family.

As will be described in more detail below, these different entities may be variously configured in accordance with the teachings herein to provide or otherwise support the features discussed briefly above. For example, the AP 110 may include an AP-side management module 112, while one or more of the STAs 120 may include a STA-side management module 122.

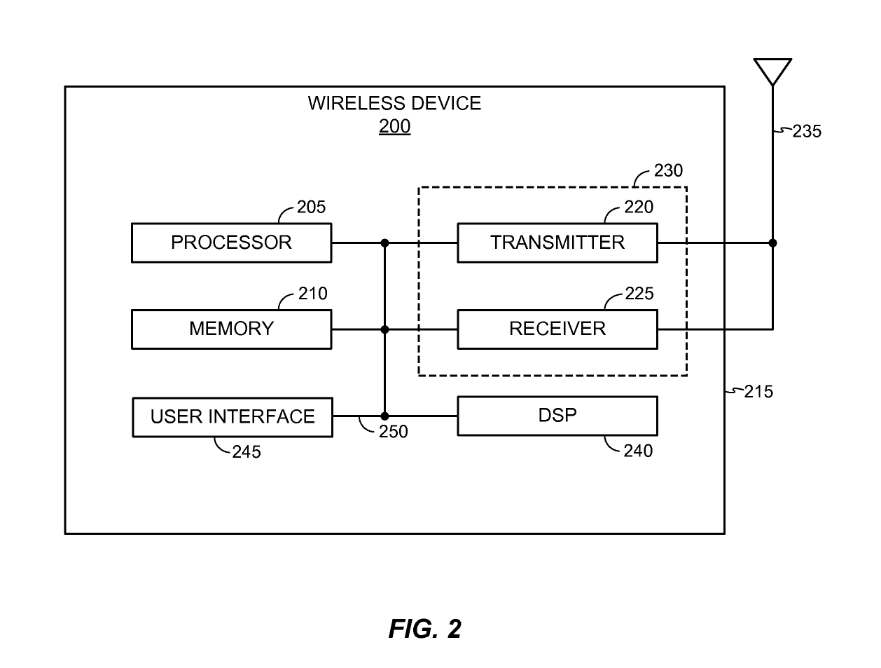

FIG. 2 depicts an exemplary functional block diagram of an exemplary user device 200, which can correspond to at least one of the STAs 120. FIG. 2 also depicts different components that can a part of the user device 200. The user device 200 is an example of a device that can be configured to include at least a portion of the apparatus described herein.

The user device 200 can include a processor 205 which is configured to control operation of the user device 200, including performing at least a part of a method described herein. The processor 205 can also be referred to as a central processing unit (CPU) and as a special-purpose processor. A memory 210, which can include at least one of read-only memory (ROM) and random access memory (RAM) provides at least one of instructions and data to the processor 205. The processor 205 can perform logical and arithmetic operations based on processor-executable instructions stored within the memory 210. The instructions stored in the memory 210 can be executed to implement at least a part of a method described herein.

The processor 205 can comprise or be a component of a processing system implemented with one or more processors. The one or more processors can be implemented with at least one of a microprocessor, a microcontroller, a digital signal processor (DSP), a field programmable gate array (FPGA), a programmable logic device (PLD), a controller, a state machine, gated logic, a discrete hardware component, a dedicated hardware finite state machine, and any other suitable entity that can at least one of manipulate information (e.g., calculating, logical operations, and the like) and control another device. The processing system can also include a non-transitory machine-readable media (e.g., the memory 210) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the processor 205, can transform the processor 205 into a special-purpose processor that causes the processor to perform at least a part of a function described herein.

The user device 200 can also include a housing 215, a transmitter 220, and a receiver 225 to allow transmission and reception of data between the user device 200 and a remote location. The transmitter 220 and the receiver 225 can be combined into a transceiver 230. An antenna 235 can be attached to the housing 215 and electrically coupled to the transceiver 230. The user device 200 can also include (not shown in FIG. 2) multiple transmitters, multiple receivers, multiple transceivers, and/or multiple antennas. The transceiver 230 can be configured to provide a wireless local area network (WLAN) air interface (e.g., in accordance with an IEEE 802.11 protocol). In an example, the transceiver 230 can be configured to provide a cellular air interface (e.g., in accordance with an LTE protocol).

The user device 200 can further comprise a digital signal processor (DSP) 240 that is configured to process data. The user device 200 can also further comprise a user interface 245. The user interface 245 can comprise at least one of a keypad, a microphone, a speaker, and a display. The user interface 245 can include a component that at least one of conveys information to a user of the user device 200 and receives input from the user.

The various components of the user device 200 can be coupled together by a bus system 250. The bus system 250 can include at least one of a data bus, a power bus, a control signal bus, and a status signal bus. Those having skill in the art will appreciate the components of the user device 200 can be coupled together to accept or provide inputs to each other using a different suitable mechanism.

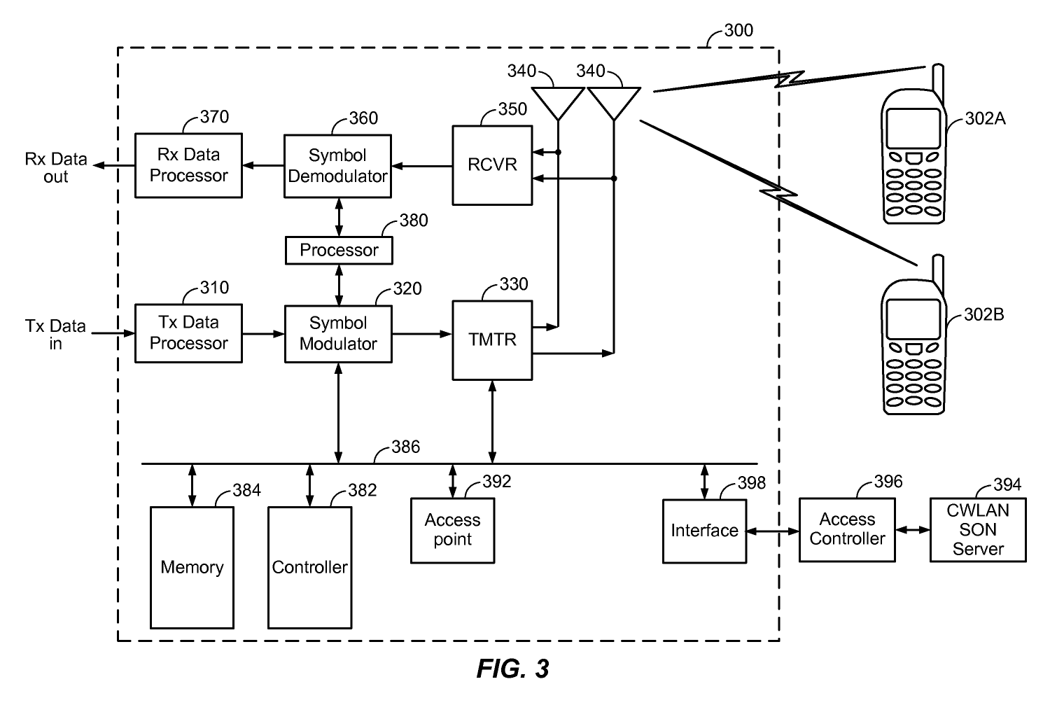

FIG. 3 depicts an exemplary access point (AP) 300. The access point 300 can correspond to any of the access points 104A-104G. As shown, the access point 300 includes a transmit (TX) data processor 310, a symbol modulator 320, a transmitter unit (TMTR) 330, an antenna 340, a receiver unit (RCVR) 350, a symbol demodulator 360, a receive (RX) data processor 370, and a configuration information processor 380, each performing an operation associated with communicating with one or more user devices 302A-302B. The user devices 302A-302B can correspond to at least one user device in a plurality of STAs 120. The access point 300 can also include a controller 382 and a memory 384 configured to store related data or instructions. Together, via a bus 386, these units can perform special-purpose processing in accordance with the appropriate radio communication technology, as well as other functions for the access point 300.

The controller 382 is configured to control operation of the access point 300. The controller 382 can also be referred to as a central processing unit (CPU) and as a special-purpose processor. The memory 384, which can include at least one of read-only memory (ROM) and random access memory (RAM) provides instructions and data to the controller 382. The controller 382 can perform logical and arithmetic operations based on program instructions stored within the memory 384. The instructions in the memory 384 can be executable to implement at least a part of a method described herein.

The controller 382 can comprise or be a component of a processing system implemented with one or more processors. The one or more processors can be implemented with at least one of a microprocessor, a microcontroller, a digital signal processor (DSP), a field programmable gate array (FPGA), a programmable logic device (PLD), a controller, a state machine, gated logic, a discrete hardware component, a dedicated hardware finite state machine, and any other suitable entity that can at least one of manipulate information (e.g., calculating, logical operations, and the like) and control another device. The processing system can also include a non-transitory machine-readable media (e.g., the memory 384) that stores software. Software can mean any type of instructions, whether referred to as at least one of software, firmware, middleware, microcode, hardware description language, and the like. Instructions can include code (e.g., in source code format, binary code format, executable code format, or any other suitable code format). The instructions, when executed by the controller 382, can transform the controller 382 into a special-purpose processor that causes the processor to perform at least a part of a function described herein.

The access point 300 can include at least one of a wireless local area network (WLAN) air interface (e.g., in accordance with an IEEE 802.11 protocol). In an example, the access point 300 can be compatible with Wireless Broadband Alliance “Carrier WiFi Guidelines” version 0.30, published 7 Feb. 2014. As shown, the access point 300 includes an 802.11 access point (AP) 392. The functionality of one or more of these components can be integrated directly into, or otherwise performed by, the controller 382 of the access point 300, sometimes in conjunction with the memory 384.

The access point 300 can communicate with the user devices 302A-302B via the AP 392. A single user device (e.g., the user device 302A) can communicate with the access point 300 via the AP 392.

In general, the AP 392 can provide an air interface (e.g., in accordance with an IEEE 802.11 protocol) over an unlicensed portion of the wireless spectrum such as an industrial, scientific, and medical (ISM) radio band. For example, the AP 392 can provide an IEEE 802.11 air interface to the user device 200 by wirelessly coupling to the user device 200.

The access point 300 can communicate with a Carrier WiFi Access Network Self-Organizing Network (CWLAN SON) server 394 via an interface 398 and (optionally) an access controller 396.

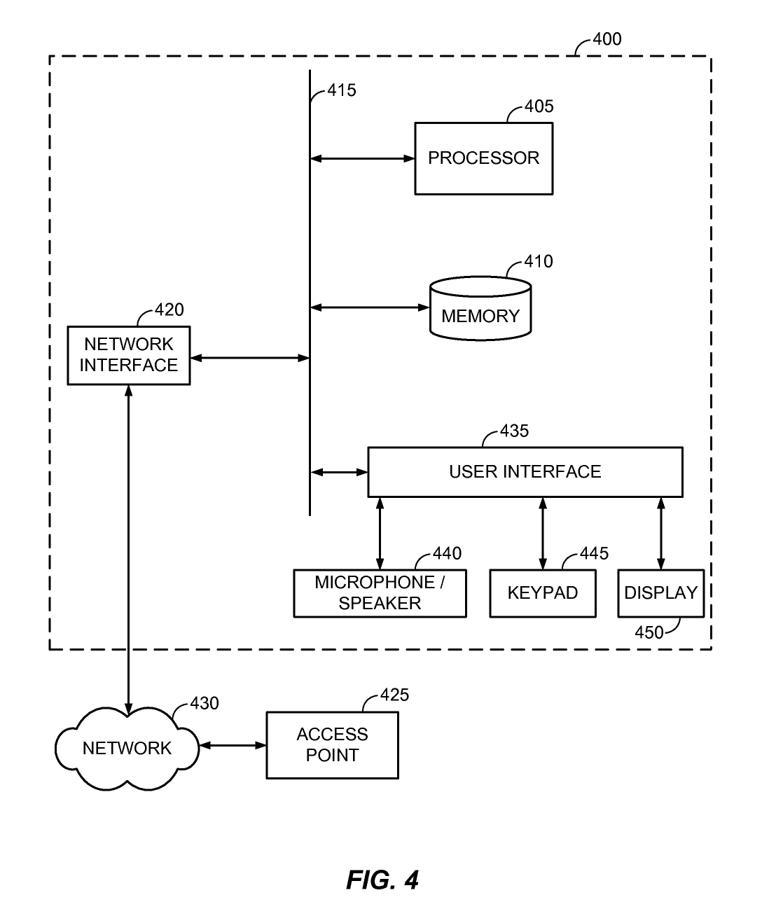

FIG. 4 depicts an exemplary CWLAN SON server 400, such as the CWLAN SON server 394. The CWLAN SON server 400 can be configured to implement at least a part of a method described herein, such as the method 500. The CWLAN SON server 394 can be integrated with a CWLAN network management system (NMS).

The CWLAN SON server 400 includes a processor 405. In addition or alternatively, the processor 405 can control one or more components of the CWLAN SON server 400, analyze information received by the CWLAN SON server 400, generate information for transmission from the CWLAN SON server 400, and/or control one or more devices coupled to the CWLAN SON server 400. The processor 405 is also configured to execute the instructions retained in a memory 410.

The CWLAN SON server 400 additionally comprises the memory 410, which is coupled to the processor 405 via a bus 415. The memory 410 can store information relating to channel selection, coordinating communications, and any other suitable information. The memory 410 can be either volatile memory or nonvolatile memory, or can include both volatile and nonvolatile memory. Further, the memory 410 can retain instructions related to at least a part of a method described herein.

The CWLAN SON server 400 additionally comprises a network interface 420 which couples components coupled to the bus 415 to an access point 425 via a network 430. In an example, the access point 425 can correspond to the access point 300. The network 430 can include at least one of the Internet, a WAN, a LAN, a virtual private network, or the like.

The CWLAN SON server 400 additionally comprises a user interface 435. The user interface 435 can interface the components coupled to the bus 415 with a user, such as via at least one of a microphone/speaker 440, a keypad 445, or a display 450.

In an example, the CWLAN SON server 400 uses an extended DL capacity utility to select WiFi channels (e.g., AP-to-STA WiFi Channels) in a manner that balances a shape of a capacity CDF curve to jointly optimize both low-percentile STA and high-percentile STA capacities for data throughput, as well as average capacity for data throughput. This joint optimization accounts for throughput and fairness when selecting WiFi channels. The CWLAN SON server 400 is configured to select the WiFi channels by collecting measurements from APs (such as APs in a network) and running a SON configuration algorithm on the collected measurement data.

The SON configuration algorithm can include calculating a utility function for each candidate channel between a specific AP and a specific STA, and then ranking that candidate channel's utility relative to the utility of another channel. In an example, all STAs to be coupled to a specific AP use the same channel, thus one channel is selected for the AP and all of the STAs use the same selected channel.

An exemplary utility function can linearly combine selected capacity percentiles (pₙ) and an average capacity (p₀) of STAs in the network. Here is an example of such a utility function: U=w₀*p₀+w₁*p₁+w₂*p₂++w_{N}*p_{N}. In this utility function, wₙ is a respective weight in a range from zero to one, with a sum of all weights used in the utility function equaling one (e.g., w₀+ . . . +w_{N}=1). For example, when p₀=average capacity, p₁=5^{th} capacity percentile, p₂=95^{th} capacity percentile, w₀=¼, w₁=½, and w₂=¼, then U=¼*(average capacity)+½*(5^{th} capacity percentile)+¼*(95^{th} capacity percentile).

The CWLAN SON server 400 selects, for an AP, the candidate channel having the highest ranked utility as the channel to use for communicating between the specific AP and the specific STAs associated with that AP. The CWLAN SON server 400 uses the algorithm results to determine a channel selection instruction, and sends the channel selection instruction to an AP (e.g., the AP 300) to reconfigure the AP. The calculating the utility function, ranking, and selecting can be performed multiple times (e.g., continuously) so that data capacity between the specific AP and the specific STA is frequently optimized.

The CWLAN SON server 400 can implement DCS by using a network capacity distribution utility, which can have the following operations:

| | |
|---|---|
| 1 | Collect measurements at a central SON server. Measurements received |
| | from an AP can include a number of associated STAs and a number of |
| | neighbor AP counts per channel. Measurements received from a STA |
| | (e.g., via an AP) can include DL useful Rx power on a channel and DL |
| | Rx interference on each channel. |
| 2 | Start channel assignments from a current, predetermined, or a random |
| | channel assignment. |
| 3 | For a defined number of iterations, proceeding in a random sequence |
| | through APs, for channels available from each AP: |

| | |
|---|---|
| a. | Calculate expected DL Capacities C_{STA} for all STAs in the |

network:

C_{STA} = (1/(N_{coch.APinrange} * N_{STAthis AP})) log2(l+SINR_{DL,STA})

Where:

N_{coch.APinrange} is the number of APs using the same channel

within the CSMA range of the AP to which the STA is
assigned.

```
  N_{STAthis AP} is the number of STAs associated with the AP.
  SINR_{DL, STA} is the DL SINR at the STA (calculated from
```

the measured useful Rx power and DL Rx interference
on the channel).

| | |
|---|---|
| b. | Select a channel for each AP which maximizes a pre- |

defined network utility.

| | |
|---|---|
| 4 | Issue a channel change command to an AP if the network utility gain |
| | (compared to a previous channel selection state) exceeds a threshold. |

The following pseudocode is an example of a network capacity distribution utility algorithm. In this exemplary algorithm, the APs are looped over twice—once for selecting a channel, and once for a capacity distribution calculation on each candidate channel. When executing the pseudocode, setting the operational channel of the AP “a” to “d” is performed “virtually” in the algorithm, for capacity calculation. The real AP channel is not changed until the end of the algorithm.

```
For n = 1:N (N = number of iterations -
absolute or with abortion criterion)
  Randomize order of APs for following for-loop
  For a = 1:A (A = number of APs) with randomized order
    For d = 1:D (D = number of available channels in AP a)
      virtually set operational channel of AP a to d
      For b = 1:A (loop over all APs)
        Calculate expected DL capacities C_{STAb}, for all STAs
        associated to AP b, on b′s current virtual channel:
        C_{STA} = (1/(N_{coch.APinrange} * N_{STAthisAP}))
        log2(1+SINR_{DL, STA})
        Where
        N_{coch.APinrange} is the number of APs using the same
        channel within the CSMA range of the AP to which the
        STA is assigned;
        • N_{STAthisAP} is the number of STAs associated with the AP;
        • SINR_{DL,STA} is the DL SINR at the STA (calculated from
        the measured useful Rx power and DL Rx interference on
        the virtual channel) Note: For the SINR, only interference
        from APs outside the CSMA range is taken into account,
        since APs will coordinate their transmissions in time.
      End (For b)
    End (For d)
    Select channel d for AP a which maximizes Network wide capacity
    distribution utility
  End (For a)
End (For n)
```

As another example that is a variation of the example above, the CWLAN SON server 400 can implement DCS by using another network capacity distribution utility, which can have the following operations:

| | |
|---|---|
| 1 | Collect measurements at a central SON server. Measurements received |
| | from an AP can include a number of associated STAs and a number of |
| | neighbor AP counts per channel. In this example, DL useful Rx power |
| | on a channel and DL Rx interference on each channel need not be |
| | measured by all STAs. |
| 2 | Start channel assignments from a current, predetermined, or a random |
| | channel assignment. |
| 3 | For a defined number of iterations, proceeding in a random sequence |
| | through APs, for channels available from each AP: |

| | |
|---|---|
| a. | Calculate expected DL Capacities C_{STA} for all STAs in the |

network:

C_{STA} = 1/(N_{coch.APinrange} * N_{STAthis AP})) log2(1+SINR_{DL,STA})

Where:

N_{coch.APinrange} is the number of APs using the same channel

within the CSMA range of the AP to which the STA is
assigned.

```
  N_{STAthisAp} is the number of STAs associated with the AP.
  SINR_{DL, STA} is the average of all reported SINRs from other
```

STAs of the AP. If none of the STAs reported a
respective SINR, then assume a predetermined constant
SINR (e.g., 15 dB) for all STAs of the AP on the
channel.

| | |
|---|---|
| b. | Select a channel for each AP which maximizes a pre- |

defined network utility.

| | |
|---|---|
| 4 | Issue a channel change command to an AP if the network utility gain |
| | (compared to a previous channel selection state) exceeds a threshold. |

In this example, the following pseudocode is a network capacity distribution utility algorithm. In this exemplary algorithm, the APs are looped over twice—once for selecting a channel, and once for a capacity distribution calculation on each candidate channel. When executing the pseudocode, setting the operational channel of the AP “a” to “d” is performed “virtually” in the algorithm, for capacity calculation. The real AP channel is not changed until the end of the algorithm.

```
For n = 1:N (N = number of iterations -
absolute or with abortion criterion)
  Randomize order of APs for following for-loop
  For a = 1:A (A = number of APs) with randomized order
    For d = 1:D (D = number of available channels in AP a)
    virtually set operational channel of AP a to d
      For b = 1:A (loop over all APs)
        Calculate expected DL capacities C_{STAb}, for all STAs
        associated to AP b, on b′s current virtual channel:
        C_{STA} = (1/(N_{coch.APinrange} * N_{STAthisAP}))
        log2(1+SINR_{DL,STA})
        Where
        N_{coch.APinrange} is the number of APs using the same
        channel within the CSMA range of the AP to which the
        STA is assigned;
        • N_{STAthisAP} is the number of STAs associated with the AP;
        • SINR_{DL,STA} is the DL SINR at the STA. If none of the
        STAs reported a respective measured useful Rx power
        and a respective DL Rx interference on the virtual channel
        d, then assume a predetermined constant SINR (e.g., 15
        dB) for all STAs of the AP b on the virtual channel d.
      End (Far b)
    End (For d)
    Select channel d for AP a which maximizes network wide capacity
    distribution utility.
  End (For a)
End (For n)
```

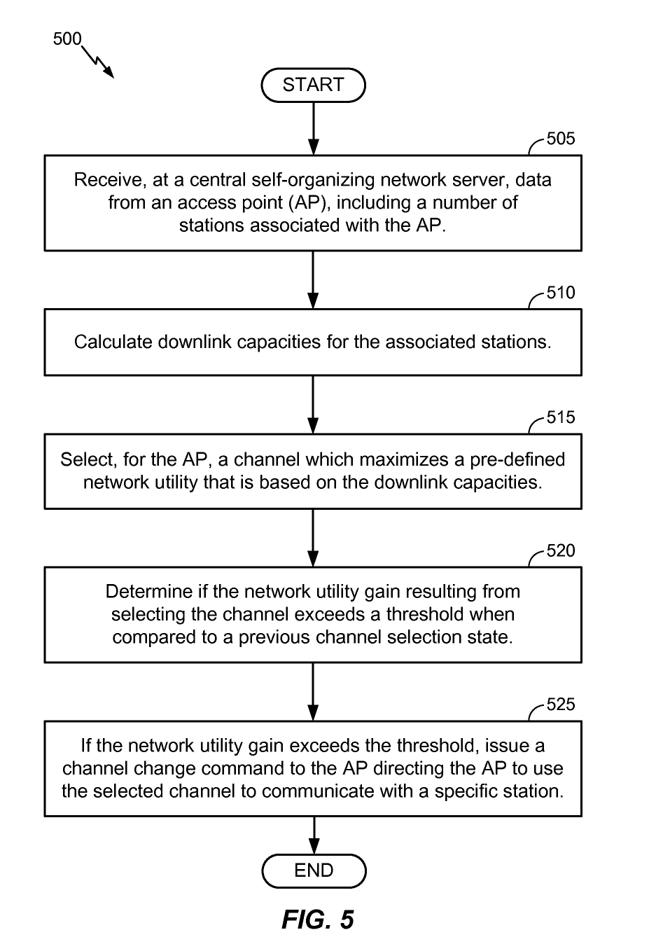

FIG. 5 depicts an exemplary method for performing dynamic channel selection 500. The method for performing dynamic channel selection 500 can be performed by the apparatus described hereby, such as by the CWLAN SON server 400 and the devices coupled to the CWLAN SON server 400.

In block 505, data from an access point (AP), including a number of stations associated with the AP, is received at a central self-organizing network server.

In block 510, downlink capacities for the associated stations are calculated.

In block 515, a channel which maximizes a pre-defined network utility is selected for the AP. The pre-defined network utility is based on the downlink capacities. In an example, a starting channel assignment can be a current channel assignment, a predetermined channel assignment, or a random channel assignment.

In block 520, it is determined if the network utility gain resulting from selecting the channel exceeds a threshold when compared to a previous channel selection state.

In block 525, if the network utility gain exceeds the threshold, a channel change command is issued to the AP directing the AP to use the selected channel to communicate with a specific station. If the network utility gain does not exceed the threshold, then do not issue a channel change command to the AP.

The foregoing blocks are not limiting of the various examples. The blocks can be combined and the order can be rearranged. The blocks in FIG. 5 can be performed by respective modules for performing the respective blocks, where the respective modules are coupled together to form an apparatus.

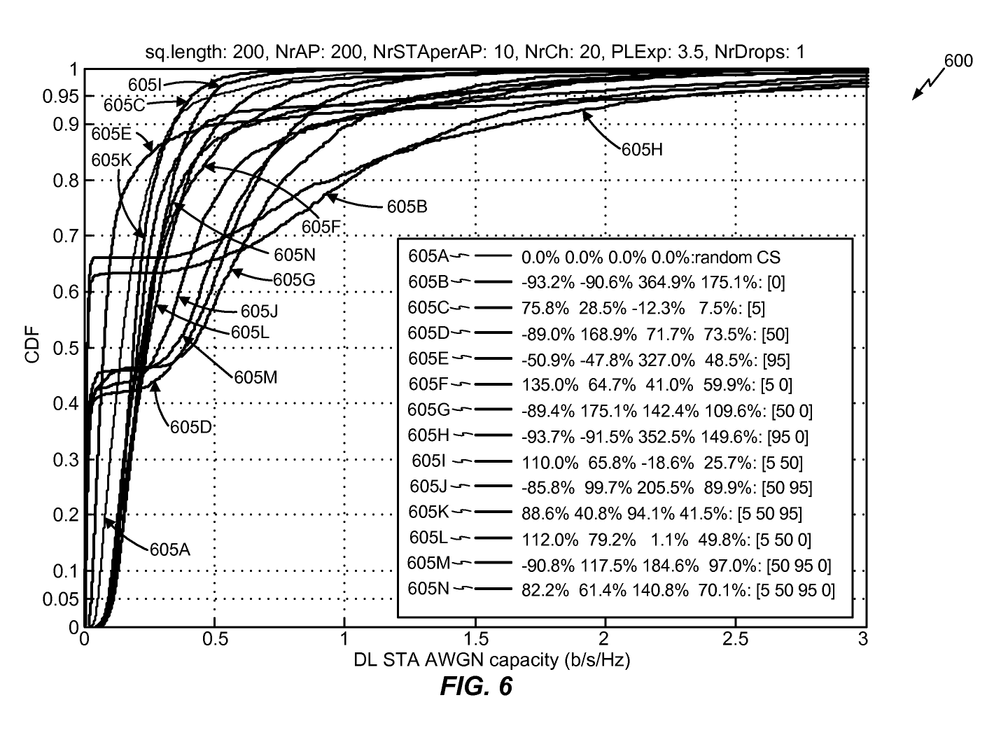

FIG. 6 depicts exemplary results 600 of implementing the method for performing dynamic channel selection 500 in a scenario where there are 200 APs, 2000 STAs, 10 STAs per AP, a 200*200 m² area, and 20 channels to be selected. The results 600 depict downlink station additive white Gaussian noise (DL STA AWGN) capacity in [(bits per second) per hertz] versus cumulative distribution capacity (CDF) percentiles.

In FIG. 6, a fiduciary capacity distribution 605A for a random channel selection (CS) provides a baseline for comparison purposes. The four percentages on the left of the key depict, respectively from left to right, percentage gains in DL STA AWGN capacity for the 5^{th} CDF percentile, 50^{th} CDF percentile, 95^{th} CDF percentile, and average across all STAs. The values in brackets (e.g., [5 50]) depict percentiles of global STA capacities that are used as percentiles in the percentile-weight linear combination that constitutes the global utility in an AP-specific channel selection utility function. A zero CDF percentile represents the average DL throughput. Equal weights, summing up to one in each individual utility, were assumed in the exemplary results.

For example, an exemplary utility function “U,” where the values in brackets are [50 0] is: U=½*(50^{th} percentile of global STA capacities)+½*(average of global STA capacities).

As another example of an exemplary utility function “U,” where the values in brackets are [5 50 95 0] is: U=¼*(5^{th} percentile of global STA capacities)+¼*(50th percentile of global STA capacities)+¼*(95^{th} percentile of global STA capacities)+¼*(average of global STA capacities).

It can be observed from FIG. 6 that the resulting capacity CDF curves (605B-N) follow the configured parameters and depict throughput improvements over a random channel selection scheme. For example, the curves which represent parameters including the 5^{th} percentile have a significantly better performance in the lower percentile range. Further, a group of four curves involving the 50^{th} percentile in their parameters boost the median of the capacity CDFs. Also, utility functions including the average capacity and 95^{th} or 50^{th} percentiles generally have a worse behavior in the lower percentiles (i.e., provide a low degree of fairness) but yield far superior results in terms of higher percentiles and average global capacity. FIG. 6 also shows that all DCS channel assignments significantly outperform random channel assignment in their targeted optimized percentiles. Also, a SNR estimation option significantly reduces signalling overhead and computational complexity of the DCS scheme.

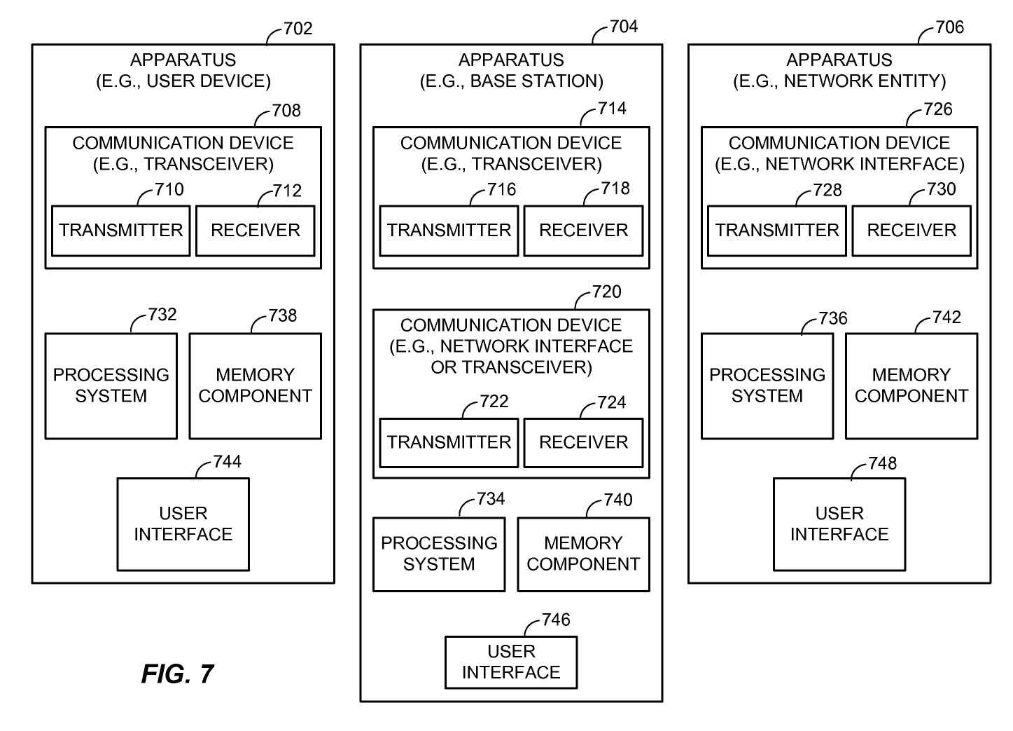

FIG. 7 illustrates several sample components (represented by corresponding blocks) that may be incorporated into an apparatus 702, an apparatus 704, and an apparatus 706 (corresponding to, for example, a user device, a base station, and a network entity, respectively) to support the operations as taught herein. It will be appreciated that these components may be implemented in different types of apparatuses in different implementations (e.g., in an ASIC, in an SoC, etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The apparatus 702 and the apparatus 704 each include at least one wireless communication device (represented by the communication devices 708 and 714 (and the communication device 720 if the apparatus 704 is a relay)) for communicating with other nodes via at least one designated RAT. Each communication device 708 includes at least one transmitter (represented by the transmitter 710) for transmitting and encoding signals (e.g., messages, indications, information, and so on) and at least one receiver (represented by the receiver 712) for receiving and decoding signals (e.g., messages, indications, information, pilots, and so on). Similarly, each communication device 714 includes at least one transmitter (represented by the transmitter 716) for transmitting signals (e.g., messages, indications, information, pilots, and so on) and at least one receiver (represented by the receiver 718) for receiving signals (e.g., messages, indications, information, and so on). If the apparatus 704 is a relay station, each communication device 720 may include at least one transmitter (represented by the transmitter 722) for transmitting signals (e.g., messages, indications, information, pilots, and so on) and at least one receiver (represented by the receiver 724) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. A wireless communication device (e.g., one of multiple wireless communication devices) of the apparatus 704 may also comprise a Network Listen Module (NLM) or the like for performing various measurements.

The apparatus 706 (and the apparatus 704 if it is not a relay station) includes at least one communication device (represented by the communication device 726 and, optionally, 720) for communicating with other nodes. For example, the communication device 726 may comprise a network interface that is configured to communicate with one or more network entities via a wire-based or wireless backhaul. In some aspects, the communication device 726 may be implemented as a transceiver configured to support wire-based or wireless signal communication. This communication may involve, for example, sending and receiving: messages, parameters, or other types of information. Accordingly, in the example of FIG. 7, the communication device 726 is shown as comprising a transmitter 728 and a receiver 730. Similarly, if the apparatus 704 is not a relay station, the communication device 720 may comprise a network interface that is configured to communicate with one or more network entities via a wire-based or wireless backhaul. As with the communication device 726, the communication device 720 is shown as comprising a transmitter 722 and a receiver 724.

The apparatuses 702, 704, and 706 also include other components that may be used in conjunction with the operations as taught herein. The apparatus 702 includes a processing system 732 for providing functionality relating to, for example, user device operations to support features as taught herein and for providing other processing functionality. The apparatus 704 includes a processing system 734 for providing functionality relating to, for example, base station operations to support features as taught herein and for providing other processing functionality. The apparatus 706 includes a processing system 736 for providing functionality relating to, for example, network operations to support features as taught herein and for providing other processing functionality. The apparatuses 702, 704, and 706 include memory components 738, 740, and 742 (e.g., each including a memory device), respectively, for maintaining information (e.g., information indicative of reserved resources, thresholds, parameters, and so on). In addition, the apparatuses 702, 704, and 706 include user interface devices 744, 746, and 748, respectively, for providing indications (e.g., audible and/or visual indications) to a user and/or for receiving user input (e.g., upon user actuation of a sensing device such a keypad, a touch screen, a microphone, and so on).

For convenience, the apparatuses 702, 704, and/or 706 are shown in FIG. 7 as including various components that may be configured according to the various examples described herein. It will be appreciated, however, that the illustrated blocks may have different functionality in different designs.

The components of FIG. 7 may be implemented in various ways. In some implementations, the components of FIG. 7 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 708, 732, 738, and 744 may be implemented by processor and memory component(s) of the apparatus 702 (e.g., by execution of appropriate code and/or by appropriate configuration of processor components). Similarly, some or all of the functionality represented by blocks 714, 720, 734, 740, and 746 may be implemented by processor and memory component(s) of the apparatus 704 (e.g., by execution of appropriate code and/or by appropriate configuration of processor components). Also, some or all of the functionality represented by blocks 726, 736, 742, and 748 may be implemented by processor and memory component(s) of the apparatus 706 (e.g., by execution of appropriate code and/or by appropriate configuration of processor components).

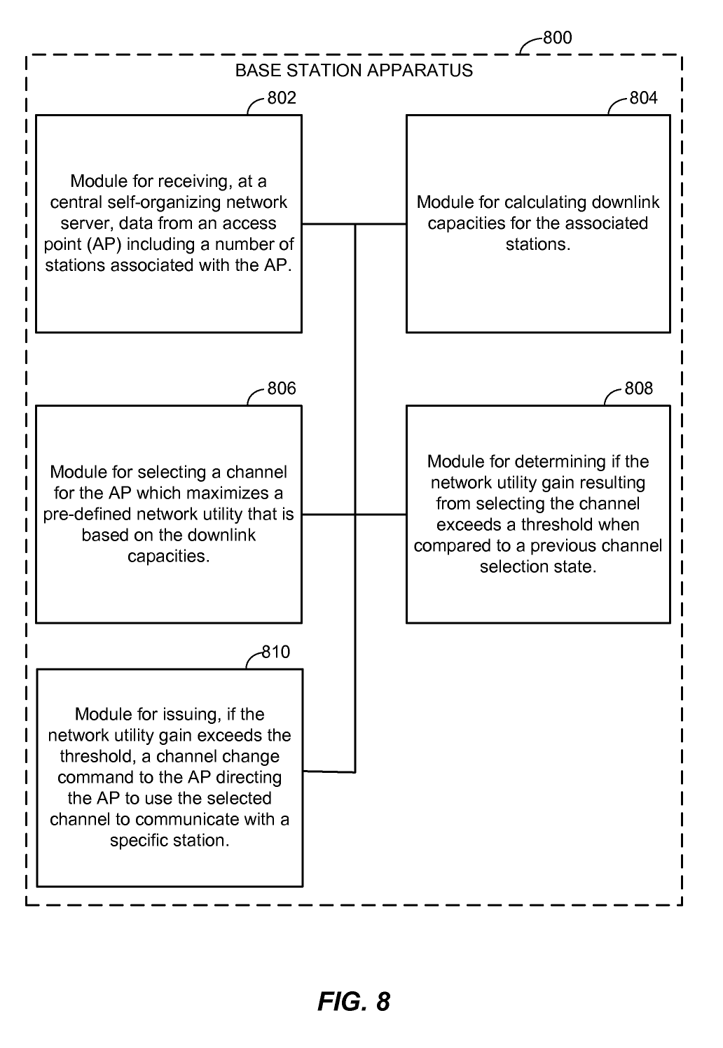

FIG. 8 illustrates an example base station apparatus 800 represented as a series of interrelated functional modules. A module for receiving, at a central self-organizing network server, data from an access point (AP) including a number of stations associated with the AP 802 may correspond at least in some aspects to, for example, a processing system in conjunction with a communication device as discussed herein. A module for calculating downlink capacities for the associated stations 804 may correspond at least in some aspects to, for example, a processing system in conjunction with a communication device as discussed herein. A module for selecting a channel for the AP which maximizes a pre-defined network utility that is based on the downlink capacities 806 may correspond at least in some aspects to, for example, a processing system in conjunction with a communication device as discussed herein. A module for determining if the network utility gain resulting from selecting the channel exceeds a threshold when compared to a previous channel selection state 808 may correspond at least in some aspects to, for example, a processing system in conjunction with a communication device as discussed herein. A module for issuing, if the network utility gain exceeds the threshold, a channel change command to the AP directing the AP to use the selected channel to communicate with a specific station 810 may correspond at least in some aspects to, for example, a processing system in conjunction with a communication device as discussed herein.

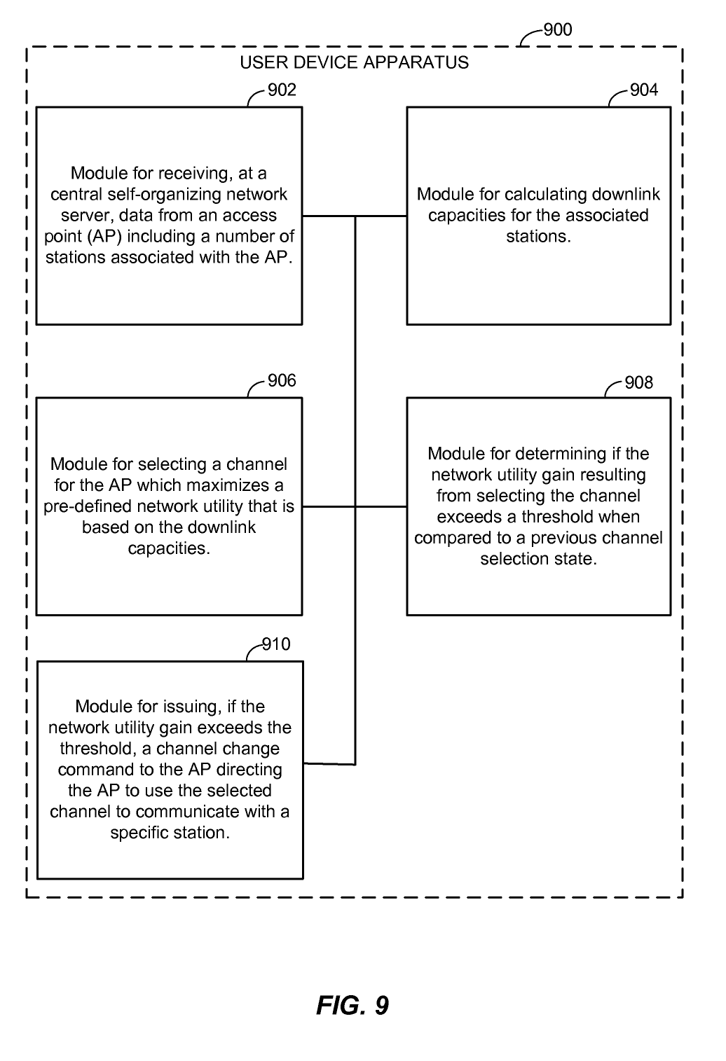

FIG. 9 illustrates an example user device apparatus 900 represented as a series of interrelated functional modules. A module for receiving, at a central self-organizing network server, data from an access point (AP) including a number of stations associated with the AP 902 may correspond at least in some aspects to, for example, a processing system in conjunction with a communication device as discussed herein. A module for calculating downlink capacities for the associated stations 904 may correspond at least in some aspects to, for example, a processing system in conjunction with a communication device as discussed herein. A module for selecting a channel for the AP which maximizes a pre-defined network utility that is based on the downlink capacities 906 may correspond at least in some aspects to, for example, a processing system in conjunction with a communication device as discussed herein. A module for determining if the network utility gain resulting from selecting the channel exceeds a threshold when compared to a previous channel selection state 908 may correspond at least in some aspects to, for example, a processing system in conjunction with a communication device as discussed herein. A module for issuing, if the network utility gain exceeds the threshold, a channel change command to the AP directing the AP to use the selected channel to communicate with a specific station 910 may correspond at least in some aspects to, for example, a processing system in conjunction with a communication device as discussed herein.

The functionality of the modules of FIGS. 8-9 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 8-9, as well as other components and functions described herein, may be implemented using any suitable means. Such means also may be implemented, at least in part, using corresponding structure as taught herein. For example, the components described above in conjunction with the “module for” components of FIGS. 8-9 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying a method as described herein.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, operations, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method for performing dynamic channel selection, comprising:
receiving, at a central self-organizing network server, data from an access point (AP) including a number of stations associated with the AP;
calculating downlink capacities for the associated stations;
selecting a channel for the AP which maximizes a pre-defined network utility that is based on the downlink capacities;
determining if the network utility gain resulting from selecting the channel exceeds a threshold when compared to a previous channel selection state; and
issuing, if the network utility gain exceeds the threshold, a channel change command to the AP directing the AP to use the selected channel to communicate with a specific station.

2. The method of claim 1, further comprising starting channel assignments from a current channel assignment, a predetermined channel assignment, or a random channel assignment.

3. The method of claim 1, wherein the calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a reported signal to noise and interference ratio from the STA on a channel.

4. The method of claim 1, wherein the calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a predetermined constant SINR for the STAs associated with the AP on the same channel.

5. The method of claim 1, wherein the calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is an average of reported signal to noise and interference ratios from other STAs associated with the AP.

6. An apparatus configured to perform dynamic channel selection, comprising:
means for receiving, at a central self-organizing network server, data from an access point (AP) including a number of stations associated with the AP;
means for calculating downlink capacities for the associated stations;
means for selecting a channel for the AP which maximizes a pre-defined network utility that is based on the downlink capacities;
means for determining if the network utility gain resulting from selecting the channel exceeds a threshold when compared to a previous channel selection state; and
means for issuing, if the network utility gain exceeds the threshold, a channel change command to the AP directing the AP to use the selected channel to communicate with a specific station.

7. The apparatus of claim 6, further comprising means for starting channel assignments from a current channel assignment, a predetermined channel assignment, or a random channel assignment.

8. The apparatus of claim 6, wherein the means for calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a reported signal to noise and interference ratio from the STA on a channel.

9. The apparatus of claim 6, wherein the means for calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a predetermined constant SINR for the STAs associated with the AP on the same channel.

10. The apparatus of claim 6, wherein the means for calculating includes using the following equation to calculate the downlink (DL) capacities for the associated stations:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is an average of reported signal to noise and interference ratios from other STAs associated with the AP.

11. An apparatus configured to perform dynamic channel selection, comprising:
a processor; and
a memory coupled to the processor and storing instructions configured to cause the processor to:
receive, at a central self-organizing network server, data from an access point (AP) including a number of stations associated with the AP;
calculate downlink capacities for the associated stations;
select a channel for the AP which maximizes a pre-defined network utility that is based on the downlink capacities;
determine if the network utility gain resulting from selecting the channel exceeds a threshold when compared to a previous channel selection state; and
issue, if the network utility gain exceeds the threshold, a channel change command to the AP directing the AP to use the selected channel to communicate with a specific station.

12. The apparatus of claim 11, wherein the memory further stores instructions configured to cause the processor to start channel assignments from a current channel assignment, a predetermined channel assignment, or a random channel assignment.

13. The apparatus of claim 11, wherein the memory further stores instructions configured to cause the processor to use the following equation to calculate the downlink (DL) capacities for the associated stations for an associated station:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a reported signal to noise and interference ratio from the STA on a channel.

14. The apparatus of claim 11, wherein the memory further stores instructions configured to cause the processor to use the following equation to calculate the downlink (DL) capacities for the associated stations for an associated station:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is a predetermined constant SINR for the STAs associated with the AP on the same channel.

15. The apparatus of claim 11, wherein the memory further stores instructions configured to cause the processor to use the following equation to calculate the downlink (DL) capacities for the associated stations for an associated station:
C_{STA}=(1/(N_{coch.APinrange}*N_{STAthis AP}))log 2(1+SINR_{DL,STA})
wherein:
C_{STA} is the DL capacity for a station (STA);
N_{coch.APinrange} is a number of APs using a same channel within a carrier sense, multiple access range of the AP to which the STA is assigned;
N_{STAthisAP} is the number of STAs associated with the AP; and
SINR_{DL,STA} is an average of reported signal to noise and interference ratios from other STAs associated with the AP.
